(19) United States
(12) Patent Application Publication
(10) Pub. No.: US 2024/0001578 A1
(43) Pub. Date: Jan. 4, 2024

(54) OPERATING METHOD FOR A SLICING MACHINE AND SLICING MACHINE SUITABLE THEREFOR

(71) Applicant: MULTIVAC SEPP HAGGENMUELLER SE & CO. KG, Wolfertschwenden (DE)

(72) Inventor: Christian DERSCH, Breidenbach (DE)

(73) Assignee: MULTIVAC SEPP HAGGENMUELLER SE & CO. KG, Wolfertschwenden (DE)

(21) Appl. No.: 18/216,047

(22) Filed: Jun. 29, 2023

(30) Foreign Application Priority Data
Jun. 30, 2022 (DE) 102022116352.0

(51) Int. Cl. B26D 7/22; B26D 7/32

(52) U.S. Cl. CPC B26D 7/22; B26D 7/32; B26D 2007/0012

(57) ABSTRACT

In a slicer, in which a number of service operations, such as cleaning operations, maintenance operations, etc., are to be carried out before and after slicing operation, it is possible according to the invention for the operator to switch from a normal slicing mode to a service mode, within which a control unit automatically and triggered by a specific start event initiates defined actions, for example after opening a specific protective door as a start event, to move moving working parts located behind it, such as a feed conveyor, into a cleaning and changing position.

### CROSS-REFERENCE TO RELATED APPLICATIONS

This application claims priority to German Patent Application No. DE 102022116352.0 filed on Jun. 30, 2022, the disclosure of which is incorporated in its entirety by reference herein.

### TECHNICAL FIELD

The invention relates to slicing machines, in particular so-called slicers, which are used in the food industry to slice strands of an only slightly compressible product such as sausage or cheese.

### BACKGROUND

Since these strands can be produced with a cross-section that retains its shape and dimensions well over its length, i.e., is essentially constant, they are called product calibers.

In most cases, several product calibers arranged parallel to one another are sliced at the same time by the same blade, which moves in a direction transverse to the longitudinal direction of the product calibers, cutting off one slice at a time in a single pass.

The product calibers are pushed forward by a feed conveyor of a feed unit in the direction of the blade of the cutting unit, usually on an obliquely downwardly directed feed conveyor, and are each guided through the product openings of a plate-shaped, so-called cutting gland, at the front end of which the part of the product caliber projecting beyond it is cut off as a slice by the blade directly in front of the cutting gland.

The slices generally fall onto a discharge conveyor of a discharge unit, by means of which they are transported away for further processing.

During slicing, the product calibers are usually held by a gripper at their rear end facing away from the cutting gland, which is provided with corresponding gripper claws for this purpose.

For reloading the slicer with new product calibers, the feeder can usually be folded down from the inclined slicing position to a horizontal loading position for easier loading.

After this has been done, the end piece that can no longer be cut is removed from the gripper, which moves away from the cutting unit to its initial position at a maximum distance therefrom, so that when the feed conveyor is subsequently pivoted upwards, the gripper is again behind the rear end of the new product caliber and can grip it.

With such contamination-intensive and wear-intensive machines, cleaning, maintenance, changeover or other work must often be carried out besides normal slicing operations.

Depending on the work to be performed, it is important that certain moving parts of the machine—i.e., those parts that are required for the job to be carried out—, in particular the very sharp blade, are in a certain position so that the work to be carried out on the machine can be performed in the first place and the risk of the operator injuring himself is reduced to a minimum.

The moving of such movable working parts into a safe position is often left to the operator himself and depends on his manual skills, but also on his risk awareness.

### SUMMARY

It is therefore the object according to the invention to provide an operating method which offers a maximum of safety for the operator during all service work to be carried out, as well as a slicing machine suitable for this purpose.

With regard to the operating method for operating a slicing machine, this problem is solved in that the operating method—which is usually controlled by an electronic control system and is stored in the control system with regard to the individual movements of the moving machine parts—can be switched between a slicing mode and a service mode.

In the slicing mode, one or more slicing programs stored in the control system are accessible and selectable, which are usually directed to different slicing tasks, for example for different products, and include all operations from the cutting of the first to the last slice of a caliber, of which several can be sliced side by side simultaneously in a slicer.

In the service mode, on the other hand, the one or more service programs stored in the control system are accessible and selectable, which are usually directed to different service actions as their purpose.

If, for example, the purpose is to enable cleaning of the machine or a component of the machine—in particular to be carried out manually by the operator—the service program comprises the approaching of a cleaning position of one or more movable working parts of the machine so that these are in such a position, that, on the one hand, the points or parts of the machine to be cleaned are accessible to the operator from the outside at all and, on the other hand, working parts of the machine which are located in the vicinity and which pose a risk of injury are located in a position which is as safe as possible, for example as far away as possible from the hands or arms of the operator when the latter is carrying out the cleaning work or the working parts are covered by covers.

A service program can thus effect a movement of a working part or a sequence of movements of a single or several different working parts of the machine, where in particular
either only a service position of certain working parts of the machine are approached, so that the operator can subsequently perform the desired service work on the machine, usually manually,
or the movements of the working parts brought about by the service program themselves bring about the necessary service work on the machine,
or as a mixed form, several movements or even movement sequences are carried out in succession by the service program, and in between the operator must manually carry out certain service work on the machine, and then as a rule must inform the control system of the completion of the respective service work steps, usually by input at the operator unit.

If the purpose of the machine is the repair or for the purpose of conversion the change of a part of the machine, the service program for this—i.e., the or one of several repair programs—includes the approaching of a repair position or conversion position of one or more movable working parts of the machine.

If, for example, the machine is to be converted from four narrow tracks to two wide tracks, the conveyor belt units involved are brought into such a conversion position that they can be easily dismantled by the operator, for example axially removed from a supporting shaft or axle.

The working parts should then be in such a position that, on the one hand, the change of the desired component by the operator is possible at all and, on the other hand, nearby working parts of the machine which are dangerous for injury are as far away as possible from the hands or arms of the operator while he is carrying out this change, or the working parts are protected against contact by the operator.

Programs whose purpose is, for example, to remove a caliber end piece from a gripper or to load the machine with a new caliber can be selectable either as slicing programs from the slicing mode, or also as service programs from the service mode.

For example, if the purpose of the service program is to load at least one path of the machine with a new caliber, this loading program may include as a service program the approaching of a loading position of one or more moving parts of the machine.

For example, the rear part of the feed conveyor for the calibers can often be folded down from a raised cutting position to an approximately horizontal loading position.

Part of such a loading program can also be the detection of the presence of a caliber in the machine, in particular on the corresponding track of the feed conveyor, which is a prerequisite for the start of the slicing operation and thus the start of the slicing program for this track.

If the purpose is, for example, the removal of a caliber end piece from one of the grippers, such an end piece removal program may comprise the approaching of an end piece removal position by one or more parts of the machine, for example the bringing of the gripper into such an end piece removal position, which may be located, for example, in the operative range of an end piece remover.

As soon as, according to the invention, the operating method is switched by the operator to the service mode, a specific service program is selected, preferably automatically, i.e., in particular by the control system of the machine, and in particular started as soon as a specific start event associated with this service program occurs at a protective part of the machine and is registered, for example, by the control system.

The start event is usually a movement or the reaching of a certain position of a movable protective part of the machine, for example a protective part such as a movable protective hood covering the cutting unit or a protective door, of which the machine housing contains several.

However, the start event may not be related to a moving protective part of the machine, but may be an event apart from the protective parts, such as the arrival of a caliber end piece on the end piece conveyor provided for it, or the detection of one or more new calibers appearing on the feeding unit.

As a rule, the start event is in any case an event that can be caused manually on the machine by the operator—also as an input on the input unit—and/or that can be detected automatically by a sensor and reported to the control system.

Accordingly, different start events are defined for the different service programs.

A specific service program is automatically triggered as soon as such a stored start event occurs.

However, it is also possible that a certain event can be the start event for several different service programs. In this case, the operator must also select—preferably in advance—which of these various service programs should be started.

Subsequent possible start events that are assigned to other service programs are ignored as long as the specific service program activated by this first start event is active.

Only events that occur after the switchover to service mode can be evaluated as start events, but it is also possible to evaluate the last event detected before the switchover as a start event, provided it is stored as a possible start event.

This makes it possible for an operator who, for example, has opened the cover for the cutting unit because he intends to replace the blade with a freshly ground blade, but has forgotten to switch to the service mode on the operator unit beforehand, to carry out this switchover only after opening the cover.

While opening the cover in normal slicing mode, i.e., while the slicing program or one of the slicing programs is active, simply brings the machine to a standstill, the subsequent switchover to service mode causes startup movements or movement sequences stored in the corresponding service program to be performed in addition to this start event.

A movement sequence can consist—in the example of the cleaning of a specific module of the machine, such as the discharge conveyor unit—for example in that, as part of this cleaning program, the individual conveyors must be wetted with a cleaning and/or disinfecting agent in defined circulating positions—i.e., positions of their conveyor belt in the direction of circulation—and then operated for a defined time at a defined circulating speed and direction of circulation, and such a sequence must be carried out several times in succession—for example with different circulating positions of the conveyor belt during wetting—as a cycle.

The previously necessary switch to the service mode and also the selection of the specific cleaning program can be carried out manually by the operator at the input unit, or can be effected automatically by the control system—and preferably also displayed at the operating unit—for example when a predetermined maximum operating time has been reached since the last cleaning. This can represent a first start event.

Then, after stopping the slicing operation, the corresponding working parts of the machine, here the individual conveyors of the discharge unit, are brought into a cleaning position necessary for this, for example into a certain height position, and also the belts are stopped in a certain circulating position intended for the 1st run of the cycle, in which, for example, a 1st half of the conveyor belt forms the upper run.

Preferably only after this has happened, the corresponding protective door, which gives access to this module of the machine, can be opened by the operator, which the control interprets as a 2nd start event, and the module is no longer moved, and he can wet, usually spray, the module with the cleaning agent.

Then the operator closes this protective door, which the control interprets as a 3rd start event and, for example, circulates the sprayed conveyors in a 1st run in the specified manner and for the specified time.

After this 1st run has been completed and, for example, the conveyors of the conveyors have been stopped with their other half in the position of the upper run, the operator can open the protective door again—which the control interprets as the next defined start event—and wet the module again with the same or also a different cleaning agent intended for the now following 2nd run of the cleaning cycle.

After closing the protective door again—which the control interprets as the next defined start event—the control will execute the 2nd run of the cleaning cycle in the predefined manner for the predefined period of time, e.g., operate the conveyors.

When the last predefined sequence of this cleaning cycle is finished, the operator can switch back to the cutting mode manually or the control can switch back to the cutting mode automatically.

If the operator opens the protective door during one of the runs of the cleaning cycle before the end of this run, which is evaluated by the control system as a special additional start event, for example, because he has still detected coarse contamination on the module, it can be stored in the control system that this special start event, after closing the protective door, either leads to a repetition or completion of the previous, aborted run, or leads directly to a transition to the intended subsequent run.

Such a service program can contain spatial as well as temporal and also further specifications.

In spatial terms, at least one movement or sequence of movements of at least one moving part of the machine is stored, for example,
in the case of a working part movable over an endless path of movement, such as an endless conveyor belt which can be driven in rotation, its movement by a certain distance, i.e., for example by a complete revolution, or its approach to a defined position, if such a position exists;
in the case of an only limitedly movable working part, for example a working part which can be moved back and forth between two end positions, for example can be pivoted back and forth, the stored movement or the movement sequence can be the approaching of a defined position, in particular one of the two end positions, of this working part.

In temporal terms, such a service program can comprise a start time and/or a time duration in which such a movement or such a movement sequence is to be performed, and/or also a specific time window within which the movement or movement sequence is to be performed, whereby in the case of a simultaneously specified time duration, the time window is then generally longer than the specifically required time duration.

In temporal terms, such a service program can also include a number of times a specific movement or movement sequence is to be performed in succession within the scope of this service program, or a detectable success event can be stored until which the stored movement or movement sequence is to be performed.

Such a success event can be—for example in the end piece removal program—the arrival of the end piece of the relevant path on an end piece removal conveyor.

If the spatial and/or temporal specifications are several specifications at the same time, for which in particular a conflict of objectives can occur, then an additional prioritization of the several specifications is stored, i.e., it is determined which specification is to be fulfilled first and which next, etc.

Furthermore, a start event may not only be a single event, but may comprise several partial events, which in particular must occur in a certain order.

For example, a first partial event can be stored as a necessary partial event for several different service programs. Which of these is to be started in concrete terms can depend on which further partial event occurs next, so that activation of a particular service program can only take place after the occurrence of at least a second partial event, since only then is a decision in favor of a particular service program possible.

With regard to a slicing machine, the existing object is solved by the fact that, on the one hand, the control system must be designed in such a way that it is able to carry out the operating procedure described above, in particular to automatically select and activate a specific service program on the basis of a start event after switching to the service mode.

For this purpose, the machine requires the appropriate sensors, i.e., at least sensors that are designed to detect a potential start event on the machine and report it to the control system.

Such a sensor is in particular a motion sensor or position sensor, which monitors a protective part of the machine, in particular a movable protective part of the machine, at which a start event can occur, for a corresponding event, e.g., a movement or reaching of a corresponding position, which represents such a start event.

Since the operator is to switch manually between the slicing mode and the service mode, a corresponding changeover switch is also required for this purpose on the machine, in particular its operating unit.

Preferably, the machine, in particular its operating unit, comprises display elements in order to be able to communicate various information to the operator, for example display elements which indicate:
which process mode is active
and/or
which service program is active
and/or
which start event was the triggering event for the currently active service
program
and/or
at which point of the motion sequence the currently active service
program is
and/or
which action is expected next from the operator by the control system
and/or
which inputs on the operating unit are currently available to the operator
and/or
which input is expected from the operator at the control unit, e.g., “disinfection time expired” or similar.

This information is not only helpful, but also partly necessary to guide the operator, who sometimes has to perform several manual steps in a certain sequence or at a certain time interval within a certain service program, safely through the corresponding service program.

### BRIEF DESCRIPTION OF THE DRAWINGS

Embodiments according to the invention are described in more detail below by way of example and with reference to the figures, which show:

FIGS. 1a, b: a slicing machine in the form of a slicer according to the prior art in different perspective views, with the feed belt folded up into the slicing position,

FIG. 2a: a simplified side view of the slicer, with some of the cladding parts removed, so that the individual conveyor belts can be seen more clearly, but with protective housing, loaded with a product caliber,

FIG. 2b: a side view as in FIG. 2a, but with the feed belt folded down into the loading position and the product caliber sliced up to a caliber end piece, also with protective housing,

FIG. 3: the slicer according to FIGS. 2a, b in top view,

FIG. 4a: a flow chart of the operating procedure of the machine, and

FIG. 4b: a flow chart of some service programs of the machine.

### DETAILED DESCRIPTION

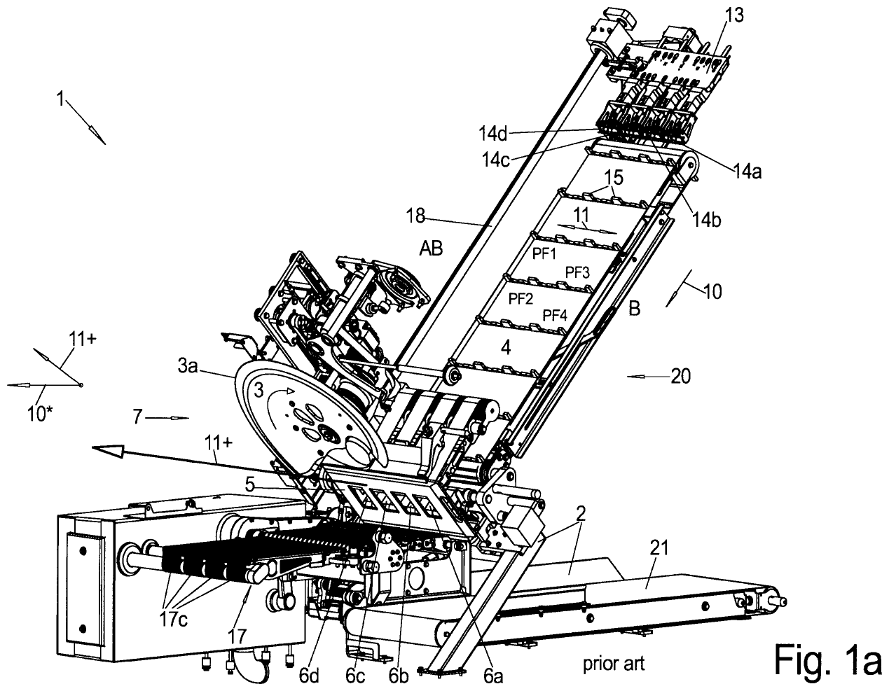

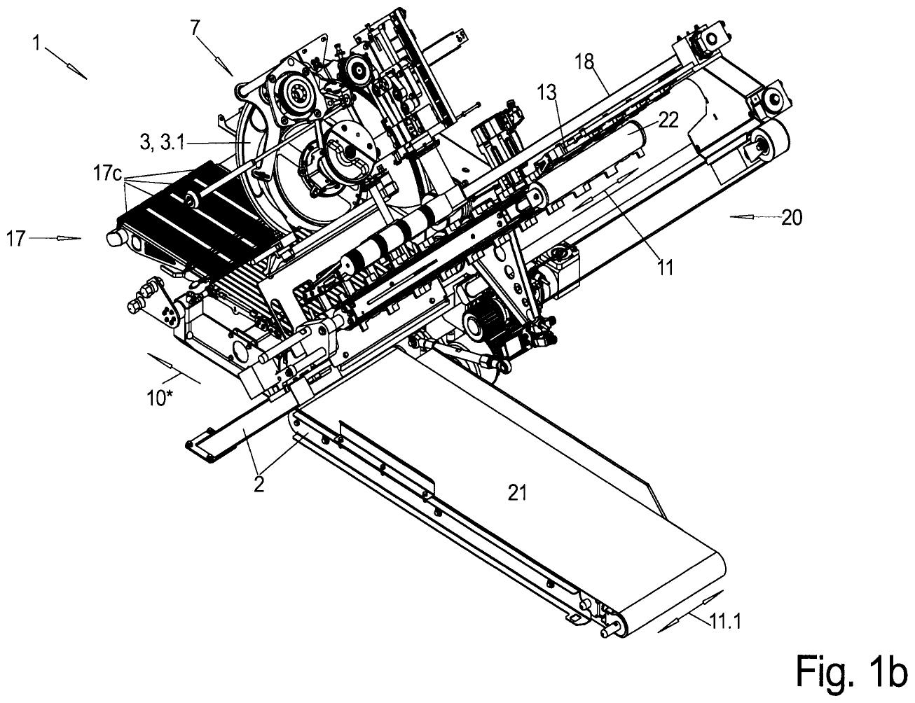

FIGS. 1a, 1b show different perspective views of a multi-track slicer 1 for simultaneous slicing of several product calibers K on a respective path PF1 to PF4 next to each other and depositing in shingled portions P each consisting of several slices S with a general direction of passage 10* through the slicer 1 from right to left.

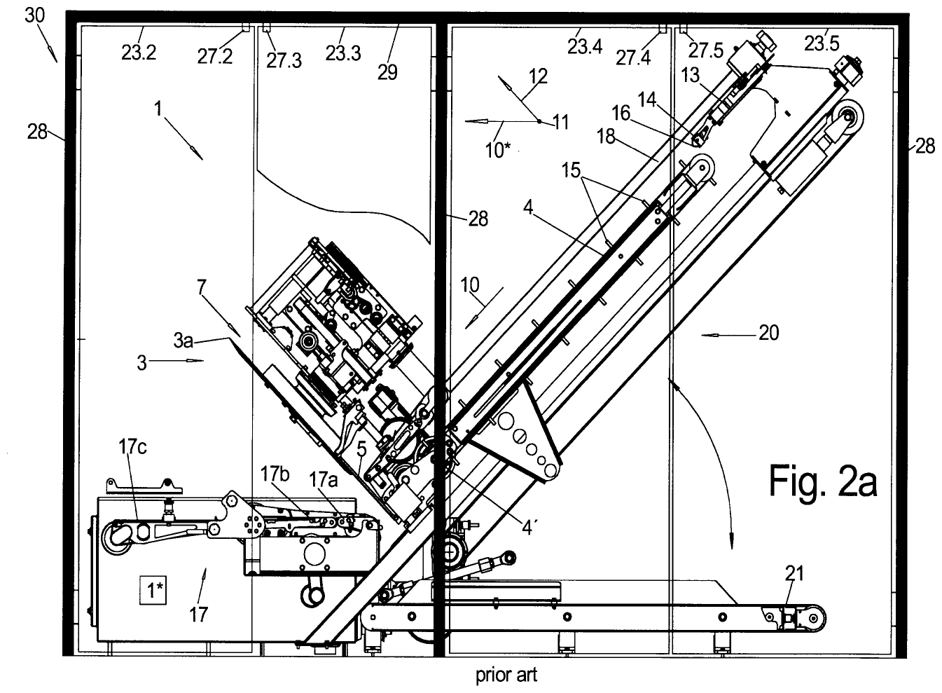

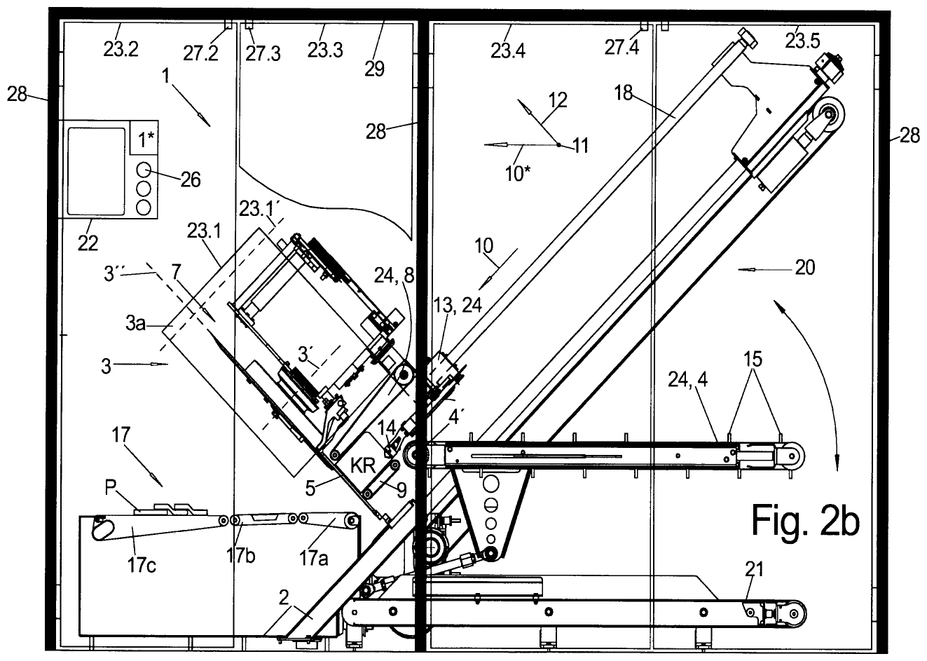

FIG. 2a shows—with the caliber K inserted—a side view of this slicer 1 omitting covers and other parts not relevant to the invention, which are attached to the base frame 2 as are all other units, so that the functional parts, especially the conveyor belts, can be seen more clearly. The longitudinal direction 10 is the feed direction of the calibers K to the slicing unit 7 and thus also the longitudinal direction of the calibers K lying in the slicer 1.

It can be seen that the basic structure of a slicer 1 according to the state of the art is that a slicing unit 7 with blades 3 rotating about a blade axis 3′, such as a sickle blade 3, has several, in this case four, product calibers K lying next to one another transversely to the feed direction 10 on a feed conveyor 4 with spacers 15 of the feed conveyor 4 between them which are fed by this feed unit 20, from the front ends of each of which the rotating blade 3 cuts off a slice S with its cutting edge 3a in one operation, i.e., almost simultaneously.

For slicing the product calibers K, the feed conveyor 4 is in the slicing position shown in FIGS. 1a-2a, which is oblique in side view with a low-lying cutting-side front end and a high-lying rear end, from which it can be folded down about a pivot axis 4′ running in its width direction, the first transverse direction 11, which is located in the vicinity of the cutting unit 7, into an approximately horizontal loading position as shown in FIG. 2b.

The rear end of each caliber K lying in the feed unit 20 is held positively by a gripper 14a-d with the aid of gripper claws 16, as shown in FIG. 2a. These grippers 14a-14d, which can be activated and deactivated with respect to the position of the gripper claws 16, are attached to a common gripper carriage 13, which can be moved along a gripper guide 18 in the feed direction 10.

Both the feed of the gripper carriage 13 and of the feeder 4 can be driven in a controlled manner, but the actual feed speed of the calibers K is effected by a so-called upper and lower product guide 8, 9, which are also driven in a controlled manner and which engage on the upper side and lower side of the calibers K to be sliced in their front end regions near the cutting unit 7:

The front ends of the calibers K are guided each through a so-called product opening 6a-d of a plate-shaped cutting frame 5, the cutting plane 3″ running directly in front of the front, obliquely downward-pointing end face of the cutting frame 5, in which cutting plane the blade 3 rotates with its cutting edge 3a and thus cuts off the protrusion of the calibers K from the cutting frame 5 as a slice S. The cutting plane 3″ runs directly in front of the front, obliquely downward-pointing end face of the cutting frame 5. The cutting plane 3″ runs perpendicular to the upper run of the feed conveyor 4 and/or is spanned by the two transverse directions 11, 12 to the feed direction 10.

The inner circumference of the product openings 6a-d serves as a counter cutting edge of the cutting edge 3a of the blade 3.

Since both product guides 8, 9 can be driven in a controlled manner, in particular independently of each other and/or possibly separately for each track SP1 to SP4, they determine the—continuous or clocked—feed speed of the calibers K through the cutting frame 5.

The upper product guide 8 is displaceable in the second transverse direction 12—which is perpendicular to the surface of the upper run of the feed conveyor 4—for adaptation to the height H of the caliber K in this direction. Furthermore, at least one of the product guides 8, 9 can be designed so as to be pivotable about one of its deflection rollers in order to be able to change the direction of the run of its guide belt resting against the caliber K to a limited extent.

The slices S standing obliquely in the space during separation fall onto a discharge device 17 which begins outside the cutting frame 5 and runs in the passage direction 10* and which in this case consists of several discharge units 17a, b, c arranged one behind the other in the passage direction 10* with the upper runs of their conveyor belts approximately aligned, of which the first discharge unit 17a in the passage direction 10* can be designed as a portioning belt unit 17a and/or can also be designed as a weighing unit.

The slices S can hit the portioning belt unit 17a individually and spaced apart from each other in the passage direction 10*, or they can form shingled or stacked portions P by appropriate control of the portioning belt 17a of the discharge device 17—the movement of which, like almost all moving parts, is controlled by the control unit 1*—by stepwise forward or backward movement of the portioning belt 22.

Below the feed unit 20 there is usually an approximately horizontal end piece conveyor 21, which starts with its front end below the cutting frame 5 and directly below or behind the discharge unit 17 and with its upper run thereon—by means of the drive of one of the discharge conveyors 17 against the passage direction 10*—transports falling end pieces to the rear.

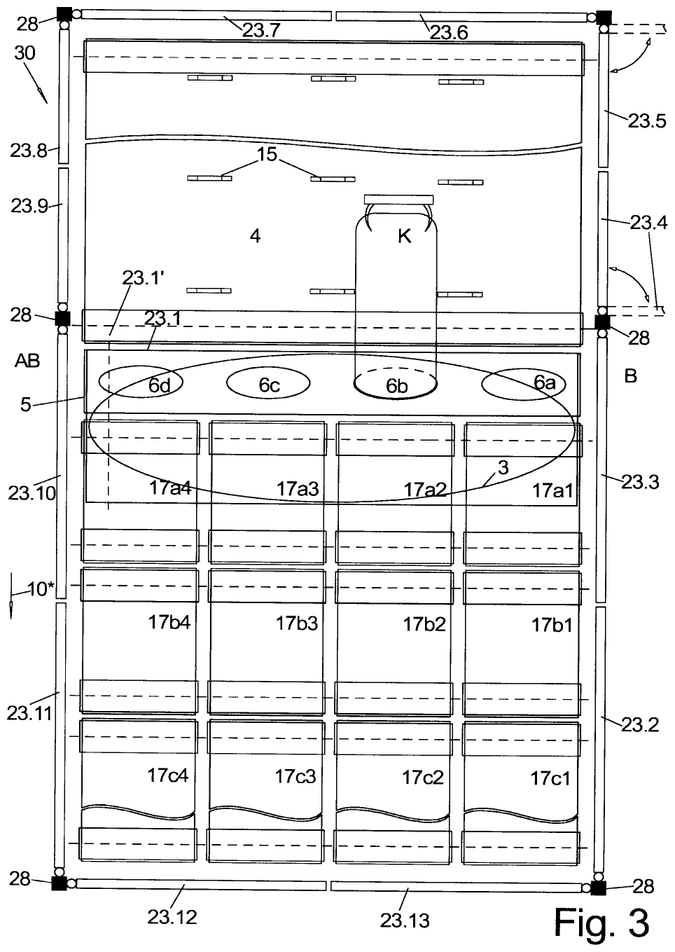

FIG. 3 shows the slicer—analogous to FIGS. 2a, b with the protective housing 30 closed for safety reasons—in top view.

It is best seen that the protective enclosure 30, viewed from above, surrounds the entire machine 1 in a rectangular shape and consists of a frame with upright posts 28 and cross-members 29 connecting the upper ends of the posts 28, whereby the area between two adjacent posts from the floor to the cross-member 29 is covered by protective doors 23.2 to 23.13, which can be pivoted about vertical pivot axes on posts 28, to such an extent that no hand can be inserted into the interior of the protective enclosure 30 through the remaining gaps.

The protective doors 23.2 to 23.13 can be swung open to the outside to provide access to the machine 1 over a large area.

For example, the protective doors 23.4 and 23.5 must be opened on the operator side B to allow access to the folded-down feed conveyor 4 from the operator side, for example to load or clean it.

Furthermore, a pivoting protective hood 23.1 is symbolically shown, which can be pivoted about a pivot axis 23.1′ lying inclined in the passage direction 10 and which, in the pivoted-down state, covers the rotating blade 3 as far as possible.

Each of these movable protective parts 23.1-23.13 is assigned an event sensor 27.1-27.13, which is attached to an adjacent, usually fixed, component such as the frame of the protective housing 30 or the housing of the cutting unit 7. The event sensor is usually a position sensor which detects the closed position of the respective protective part and reports this to the control unit 1 and, if the protective part is not completely closed, emits an alarm signal to the control unit 1* which is interpreted by the latter as a start event in service mode SM if this is already activated or is activated by the operator immediately after the start event.

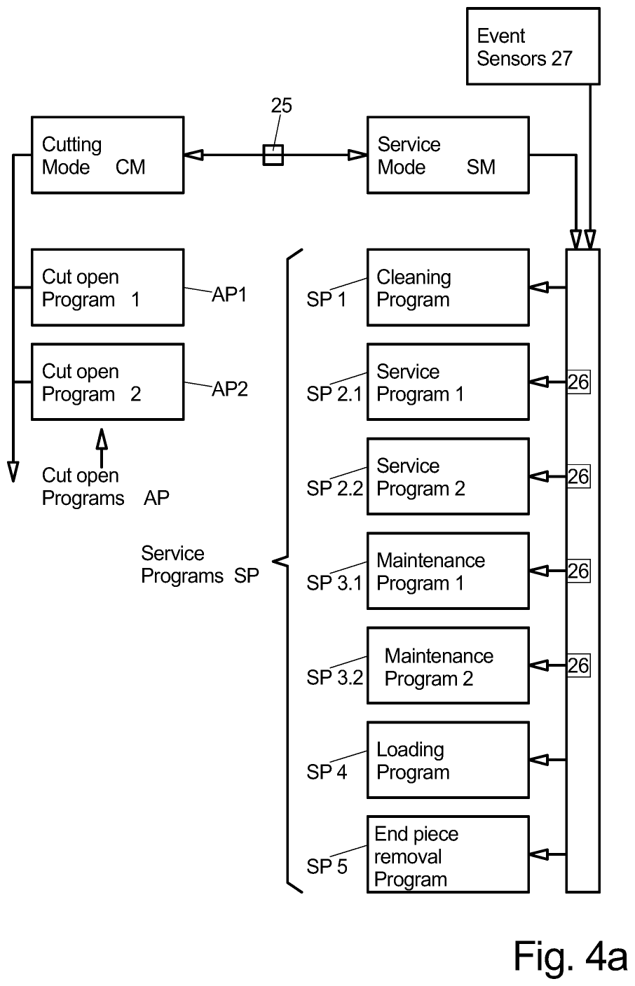

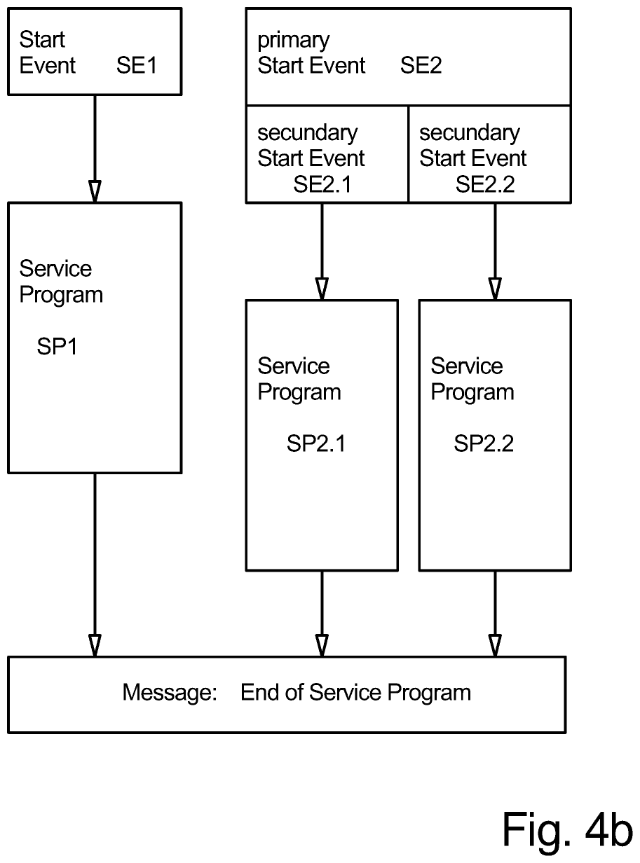

FIG. 4a shows on the basis of the flow chart of the operating method that there the operator first selects between the cutting mode CM and the service mode SM of the machine 1 by means of a changeover switch 25—which is usually present on the operating unit of the machine 1 not shown:

To carry out a work order, he switches to the slicing mode CM, which usually comprises several slicing programs AP1, AP2, etc., and selects the slicing program suitable for his current work order, for example on the basis of the type of product to be sliced or the portions to be produced, for example the slicing program AP2, and slices the product pieces or calibers K.

If service work has to be carried out on machine 1—which may also be indicated to the operator by control 1* of machine 1 with regard to the time, and may therefore also be necessary in the middle of the running work order—the operator switches to service mode SM by means of changeover switch 25, whereupon the slicing operation is aborted or at least interrupted.

If the service work to be performed requires the protective door 23.1 to be opened, for example, the operator opens this protective door 23.1, which is registered by an event sensor 27.1 mounted there—for example a position sensor that detects that the protective door 23.1 is now no longer in the closed position—and reported to the control 1*.

If the opening of this protective door 23.2 is stored in the control system as a start event for only one specific service program, for example the cleaning program SP1, the control system 1* then usually starts this service program SP1 immediately.

If the opening of this protective door 23.2 is stored in the control 1* as the only or primary start event for different service programs, for example SP2.1 and SP2.2—in this case two different repair programs for the repair of, for example, different components of the machine 1—then two cases must be distinguished:

If the opening of this protective door 23.2 is the only stored start event for both service programs SP2.1 and SP2.2 in question, the operator must inform the control 1* by means of a selector switch 26—which is also usually present on the service unit 22—which specific one of the two service programs in question in this case he wishes to execute.

For this purpose, the control unit 1* usually offers him only these two service programs SP2.1 and SP2.2 for selection after opening the protective door 23.1. Only after the selection can the control unit start the selected service program, for example SP 2.1.

If, according to FIG. 4b, the opening of the protective door 23.2 is the primary start event SE2 for both SP2.1 and SP2.2, but a second secondary start event SE2.1 or SE2. 2 is stored in the control unit, the operator must first additionally cause one of these two different secondary start events, whereby he indirectly selects one of the two, e.g., the service program SP2.2, without further input at the operating unit 22, and this service program SP2.2 is then started by the control unit 1*.

Of course, the secondary start event, like the primary start event, is usually an operation that the operator must perform anyway in order to perform the desired service work.

If the movement of a working part 24 of the machine 1 or sequence of movements of one or more working parts 24 of the machine 1 stored in a service program already poses a risk of injury to the operator,
the operator can be indicated by a warning signal, for example a signal lamp, in particular directly at the working part to be moved by the movement sequence, when the working parts are in the service position and the operator may start the service work or
the working part 24 to be moved into the service position, for example the blade 3, is protected by a further, still closed protective part 23, for example the cover 23.1, which only opens when the movement or sequence of movements of the working parts 24 stored in the service program has been completed.

The latter can be achieved, for example, by opening a protective door 23.2—which represents the start event—only a small gap at first, which does not yet allow an arm to be pushed through, and this protective door 23.2 can only be opened further—as is necessary for carrying out the service work—after the corresponding service program SP has moved the working parts 24 concerned into the service position.

When the service work is completed—which may require one or more corresponding completion messages from the operator at the control unit 22, but in any case a final closing of all guard parts 23, which is detected by the corresponding event sensors 27—the control unit 1* emits a signal that the machine 1 can now be switched back to the cutting mode CM.

### LIST OF REFERENCES

1 slicing machine, slicer
1* control
2 base frame
3 blades
3 rotation axis
3″ blade plane, cutting plane
3a cutting edge
4 feeding conveyor, feeding belt
5 cutting frame
6a-d product opening
7 cutting unit
8 upper product guide, upper guide belt
8.1 contact run, lower run
8a gland-side deflection roller
8b gland-averted deflection roller
9 lower product guide, lower guide belt
8.1 contact run, upper run
9a gland-side guide roller
9b gland-averted deflection pulley
10 transport direction, longitudinal direction, axial direction
10* passage direction through machine
11 1^{st} transverse direction (width slicer)
12 2^{nd} transverse direction (height direction caliber)
13 gripper unit, gripper slide
14,14 a-d gripper
15 spacer
15′ support surface
16 gripper claw
17 discharge conveyor unit
17a, b, c portioning belt, discharge conveyor
18 gripper guide
19 height sensor
20 feeding unit
21 end piece conveyor
22 operating unit
23 protective part, protective door, protective hood
24 working part
25 change-over switch
26 selector switch
27.1/.2/.3 sensor, event sensor
28 post
29 crossbar
30 protective enclosure
AP1, AP2 slicing program
CM slicing mode
SM service mode
K product, product caliber
KR end piece
PF1/2/3 path
S slice
P portion
SP1, SP2.1 service program

1. An operating method for operating a slicing machine, in particular a slicer, for slicing calibers into slices and, if required, creating shingled or stacked portions from slices, wherein
the operating method can be switched between a slicing mode and a service mode,
the service mode comprises several service programs aimed at different purposes,
after switching to the service mode at least one, in particular exactly one, service program is automatically selected and optionally started, triggered by at least one start event occurring and detected, usually at a protective part of the machine.

2. The method according to claim 1,
wherein
after switching to the service mode and a start event detected by the control unit, the control unit offers the operator a number of possible service programs for selection.

3. The method according to claim 1,
wherein
the part, in particular protective part, of the machine at which the at least one start event occurs is a movable protective part,
the start event is a detected movement of the protective part.

4. The method according to claim 1,
wherein
a service program in spatial terms comprises as a preset at least one movement, in particular a stepwise movement sequence, of a movable working part of the machine, namely
in the case of a working part movable over an endless path of movement
its movement by a defined distance,
its approach to a defined position,
in the case of a working part movable only along a limited path of movement,
its approach to a defined position, in particular an end position, of the limited movement path.

5. The method according to claim 1,
wherein
a service program comprises in temporal terms as a preset
a time duration and/or
a start time and/or
a time window (define) and/or
a repetition number for a movement or the movement sequence of at least one movable working part.

6. The according to claim 1,
wherein
a service program
in the case of several specifications, contains a prioritization of the specifications
and/or
contains a detectable target event or a target event to be reported by the operator to the controller, which defines the end of the service program.

7. The method according to claim 1,
wherein
for enabling a cleaning of the machine as purpose of the service program, this comprises the approaching of a cleaning position of one or more movable working parts of the machine or
for enabling a repair or conversion of the machine as purpose of the service program, this comprises the approaching of a repair position or conversion position of one or more movable working parts of the machine, or
for enabling a loading of the machine with a new caliber as purpose of the service program, this comprises the approaching of a loading position of one or more movable working parts of the machine, in particular of the feed conveyor, in particular including detection of the presence of a caliber in the machine or
for enabling a removal of an end piece of a caliber from a gripper and discharge from the machine as a purpose of the service program, this comprises the approaching of an end piece removal position of one or more movable working parts of the machine, in particular of the gripper.

8. The method according to claim 1,
wherein
the start event can comprise several partial events, in particular occurring in a specific sequence,
in particular separate start events for the individual processes of a service measure, which must take place one after the other within a cycle, but in which, in particular in between, the operator must carry out activities, in the context of the start or completion of which start events again occur.

9. The method according to claim 1,
wherein
the first event occurring at the movable protective parts of the machine after switching to the service mode or the last event occurring before that is interpreted as the start event.

10. A slicing machine, in particular slicer, for slicing calibers into slices and creating shingled or stacked portions from slices, comprising:
a cutting unit,
a feeding unit for feeding at least one caliber to the cutting unit,
a discharge unit with at least one portioning belt,
a control unit including an operating unit for controlling movable parts of the slicing machine,
wherein
the control unit is designed to be able to perform the operating method described in the claim 1,
the control unit comprises a change-over switch for switching between cutting mode and service mode M,
sensors are present on the machine, which are designed to detect a potential start event and report it to the control unit.

11. The slicing machine according to claim 10, wherein
the sensor is a motion sensor or position sensor for monitoring moving parts, in particular protective parts, in particular a moving protective door, of the machine at which a start event can occur.

12. The slicing machine according to claim 10,
wherein
the machine, in particular the operating unit, comprises at least one display element for displaying
which process mode is active and/or
which service program is active
and/or
which start event was the triggering event for the currently active service program
and/or
at which point of the motion sequence the currently active service program is located
and/or
which action is expected from the operator
and/or
which inputs on the operating unit are currently available to the operator
and/or
which input is expected from the operator at the operating unit.

13. The slicing machine according to claim 10,
wherein
the operating unit comprises a selector switch for selecting a specific service program in the service mode.
